(19) United States
(12) Patent Application Publication
(10) Pub. No.: US 2008/0079543 A1
(43) Pub. Date: Apr. 3, 2008

(54) Apparatus for identifying and counting articles in bulk

(76) Inventors: Bruno Fabre, Cavaillon (FR); Guy Venture, Senas (FR)

Correspondence Address: YOUNG & THOMPSON, 745 SOUTH 23RD STREET, 2ND FLOOR, ARLINGTON, VA, 22202, US

(21) Appl. No.: 11/520,759

(22) Filed: Sep. 14, 2006

(51) Int. Cl. G05B 23/00

(52) U.S. Cl. 340/10.2; 340/572.1; 340/572.5; 340/5.92

(57) ABSTRACT

The invention provides apparatus for detecting articles (1) by implementing radiofrequency type means, the apparatus comprises a transmitter member (4) for transmitting a signal at given frequency and given amplitude, a receiver member (5) for receiving the transmitted signal, and an RLC type element (3) fitted to each article (1). The transmitter member (4) transmits sequentially a plurality of signals (A, B, C, D) at respective frequencies. The articles (1) are distributed by article type and each article of a given type is fitted with an RLC type element (3) that is resonant at a respective frequency. When a batch of articles (1) in bulk passes through the space (11) extending between the transmitter member (4) and the receiver member (5), attenuation is generated in the amplitude of the transmitted signals (A, B, C, D) corresponding to each article type, and this attenuation is detected by the receiver member (5), which consequently generates corresponding information relating to the presence or absence of an article (1) of the type identified by the RLC element (3) of the specific type carried by the article. The invention is applicable to verifying that the articles (1) in a delivery match the articles in the order for that delivery.

The invention relates to the field of mechanisms for identifying and counting articles that are distributed randomly. It provides apparatus for identifying and counting articles, and it is particularly applicable to the field of trade for verifying that the articles handed over to a customer match the articles in a previously-recorded order. The invention is also particularly suitable to sorting articles from a plurality of articles.

### BACKGROUND OF THE INVENTION

Mechanisms are known for identifying and counting articles. In general, such mechanisms comprise a signal transmitter member co-operating with a cell carried by the article. The cell is a source of information that is picked up by a member for receiving the transmitted signal as returned by the cell.

More particularly, mechanisms have been proposed for identifying stored articles in order to perform automatic inventory control. Each article carries a cell constituted by a resonant transponder, the article being placed on a suitable medium. A signal transceiver member serves repeatedly to scan a set of transmit/receive frequencies so that all the goods belonging to a specific stock control unit placed on a rack are interrogated collectively. The data returned by the transponders in response to each set of particular frequencies is stored and combined mathematically by computer means for giving the total number of articles. The signal transceiver member is movable so as to travel along the rack carrying the articles. More precisely, the signal transceiver member transmits at a pair of frequencies allocated to a given storage unit. The articles are fitted with labels that resonate at the original pair of frequencies and that retransmit simultaneously on a third frequency to which the receiver portion of the signal transceiver member is tuned. Reference can be made for example to patent document FR 2 557 714 (Revlon) which describes a mechanism of that kind.

Proposals have also been made in the field of identifying and counting articles applied to trade for an apparatus that is to identify and count articles contained in a receptacle. Such an apparatus is particularly intended for the field of supermarkets or similar stores. More particularly, the apparatus serves to verify automatically that the articles placed inside a receptacle leaving the store, for the purposes of identifying them, of counting them, and of establishing a corresponding invoice. The apparatus comprises respective transmitters allocated to each of the articles for transmitting data identifying the articles to a data receiver member, and then in using said data for calculating the total price for the articles contained in the receptacle. By way of example, reference can be made to patent document U.S. Pat. No. 5,239,167 (Ludwig Kipp) which describes such apparatus.

It can be seen that those apparatuses make use of members that are expensive. Their complexity and their large cost price are due mainly to their application to counting articles that need to be identified from amongst a large number of possible different articles. Nevertheless, there are numerous applications in which the number of different types of article for identification and for counting is small, say about 50, and complex and expensive apparatuses are not adapted to such applications.

Also known in the field of trade are antitheft apparatuses located at the exit from a store. Those radiofrequency apparatuses make use of a transmitter member for transmitting a signal at a given frequency and a given amplitude, and of a receiver member for receiving the signal. Customers are constrained to pass between those two transmitter and receiver members. All the articles in the shop are fitted with a single type of label that carriers an RLC type cell associating a resistor, an inductor, and a capacitor. The cells serve to modify the amplitude of the transmitted signal. In the event of such a cell going down the path provided between the signal transmitter member and the signal receiver member, then the change in the amplitude of the signal as attenuated by the cell is detected by the receiver member and a warning is triggered.

The advantage of such radiofrequency apparatuses lies in their simple structure and in their low cost price. It should be noted that the use of labels carrying an RLC type cell is advantageous because of their low cost. Nevertheless, in their present state, such apparatuses are suitable solely for detecting the presence or absence of any article in the store within the passage formed between the transmitter member and the signal receiver member.

### OBJECT AND SUMMARY OF THE INVENTION

The object of the present invention is to provide inexpensive apparatus for counting and identifying articles placed in bulk in a receptacle, and in particular for quantitative and qualificative identification of the articles. More particularly, the invention seeks to provide such apparatus that is applicable, because of its low cost price, to counting and identifying an arbitrary number of articles in bulk of types that are different, but selected from a set of article types that are known in number. More particularly, the present invention proposes such apparatus for identification and counting purposes that is applicable to verifying that the articles actually handed over to a customer match the articles in a previously-recorded order.

The invention provides apparatus for detecting articles that implements radiofrequency type means. Such radiofrequency type means serve more particularly to implement one transmitter member for transmitting a signal at a given frequency and a given amplitude, at least one receiver member for receiving the transmitted signal, and at least one RLC type element associating a resistor, an inductor, and a capacitor.

Each article for detection is fitted with such an RLC element so that when the article passes through a space extending between the transmitter member and the receiver member, it induces an attenuation in the amplitude of the transmitted signal, which attenuation is detected by the receiver member. This detected attenuation generates information. It should be observed that the apparatus of the invention is of the radiofrequency type as used for detecting the theft of articles from stores, where articles for detection are caused to travel along a space that extends between the signal transmitter member and the receiver member for receiving the transmitted signal, and in which the articles are fitted with respective throwaway RLC elements, given that the cost of such elements, in particular those carried by labels, make it economically feasible for them to be discarded after use.

In the present invention, apparatus of the above-specified kind is mainly recognizable in that the transmitter member is a member for sequentially transmitting a plurality of signals at respective frequencies. The articles are subdivided by article type, with each article of a given type being fitted with an RLC element of a corresponding type that is resonant at a respective frequency corresponding to one of the various signals that are transmitted sequentially. These dispositions are such that when a batch of articles of different types in bulk passes through the space extending between the transmitter member and the receiver member, attenuation is generated for each type of article present in the batch, with the magnitude of the attenuation in the corresponding transmitted signals being detected by the receiver member, thus making it possible to generate corresponding information relating at least to the presence or absence of articles of the type identified by the specific type of RLC element carried by each article.

More precisely, each article carries a respective RLC element, the articles of any one type all carrying an RLC element of a type that resonates at the same transmitted signal frequency. The transmitter member transmits signals corresponding to each type of RLC element in sequence. The articles are presented in bulk in the space extending between the transmitter member and the receiver member. For a given type of article present in said space, the amplitude of the corresponding transmitted signal is attenuated by the RLC element carried by the article, with this signal attenuation being detected by the receiver member. For each modification in a respective transmitted signal, the presence of an article carrying the RLC element corresponding to said signal is detected. As a result, by sequentially transmitting signals at the respective frequencies, and by the articles passing in bulk through said space extending between the transmitter member and the receiver member, the receiver member detects a change in the amplitude of any of the transmitted signals and this corresponds to information about the presence of an article of a type previously identified from the specific type of RLC element it is carrying.

Preferably, when the receiver member detects attenuation in the amplitude of a signal at a given frequency, that generates information relating to the quantity of articles of the same type that have been detected. This information is generated by measuring the magnitude of the attenuation in the detected signal, the apparatus being fitted with such measurement means.

More precisely, the receiver member is not only fitted with means for detecting variation in the amplitude of the transmitted signal, but also with means for quantifying said variation, in order to generate information relating to the quantity of RLC elements of a given type present in the space extending between the transmitter member and the receiver member.

It should be observed that said measurement of the magnitude of the signal attenuation as detected advantageously corresponds to performing measurements of said attenuation in steps, with each step corresponding to some number of RLC elements of the corresponding type being present in the space extending between the transmitter member and the receiver member.

By way of example, the signals transmitted by the transmitter member lie in a frequency range extending from about 1 megahertz (MHz) to about 40 MHz.

As an indication, the duration for which each of the sequentially-transmitted signals is transmitted is about 10 milliseconds (ms).

The duration over which a sequence of signals is transmitted is preferably about 1 second (s).

The apparatus includes in particular a computer for compiling the information generated by detecting the attenuations as detected by the receiver member. The computer is in communication with memory means associating each type of RLC element with the corresponding type of article. These dispositions make it possible to analyze the signal attenuations as detected by the receiver member in order to associate each attenuation with the corresponding type(s) of article present in the space between the transmitter member and the receiver member, and where appropriate with the numbers of articles in each article type.

Preferably, the apparatus includes display means associated with the computer to display at a control station the types of article detected in the space extending between the transmitter member and the receiver member.

Also preferably, the apparatus is further associated with means for inputting and storing an order for articles of determined types and in determined numbers, and comparator means for comparing the order with the articles detected as they pass through between the transmitter member and the receiver member. These dispositions are such that, where appropriate, warning information can be generated in the event of the detected articles not matching the order for articles.

In a variant embodiment, the apparatus comprises a plurality of pairs of transmitter and receiver members oriented along respective directions in a rectangular frame of reference, with the space extending between these various pairs transmitter and receiver members thereby enabling the information generated to be made more pertinent.

It should be observed that the RLC element fitted to each article is in particular an element of the type carried by a label that is applied to the article. Nevertheless, other techniques could be envisaged for applying such RLC elements to articles without going beyond the ambit of the invention, for example by marking the articles using a conductive ink, e.g. an ink based on silver or some other conductive material.

A privileged use for the apparatus of the present invention lies in verifying compliance between orders for articles and the articles detected in the space extending between the transmitter member and the receiver member.

More particularly, this has been found to be useful in the fast food domain, in particular for drive-through service, whereby customers present in a vehicle give an order to an operator, and the order is then delivered to the customers in their vehicle. It has been found useful to implement the apparatus of the present invention in that type of service, insofar as the number of different types of article available to the consumer is limited and known, and insofar as a consumer who has taken possession of an order is frequently not in a position to verify immediately that the order as delivered matches the order as made, given that the customer is at the wheel of a vehicle and is expected to move on quickly so as to enable the following customers to pick up their orders. It will be understood that under such circumstances, the space that extends between the transmitter member and the receiver member through which the goods pass while contained in bulk in a receptacle is preferably disposed in the vicinity of and upstream from the booths used by the operator for handing over orders to customers.

More particularly, a method of implementing apparatus of the present invention consists:
in inputting and storing an order comprising at least one article of at least one article type;
in preparing the order and placing articles corresponding to said order in bulk in a receptacle, each article being fitted with an RLC element of a type that corresponds to the type of the article;
in placing the receptacle containing the articles in a space extending between the transmitter member and the receiver member;
in sequentially transmitting different signals at respective frequencies from the transmitter member, and in detecting any attenuation in each of the transmitted signals;
in comparing the type and number of the articles as detected with the corresponding articles in the order; and
where appropriate, generating information relating to a mismatch between the order as input and the articles contained in the receptacle.

Other applications can make use of apparatus of the present invention, such as an application to antitheft apparatus or an application to sorting articles.

### BRIEF DESCRIPTION OF THE DRAWING

The present invention can be better understood and details concerning it appear on reading the following description made with reference to the figures of the accompanying drawing, in which:

FIG. 1 is a diagrammatic view showing an embodiment of apparatus of the present invention; and

FIG. 2 is a diagram showing an application of apparatus of the invention to the fast food business.

### MORE DETAILED DESCRIPTION

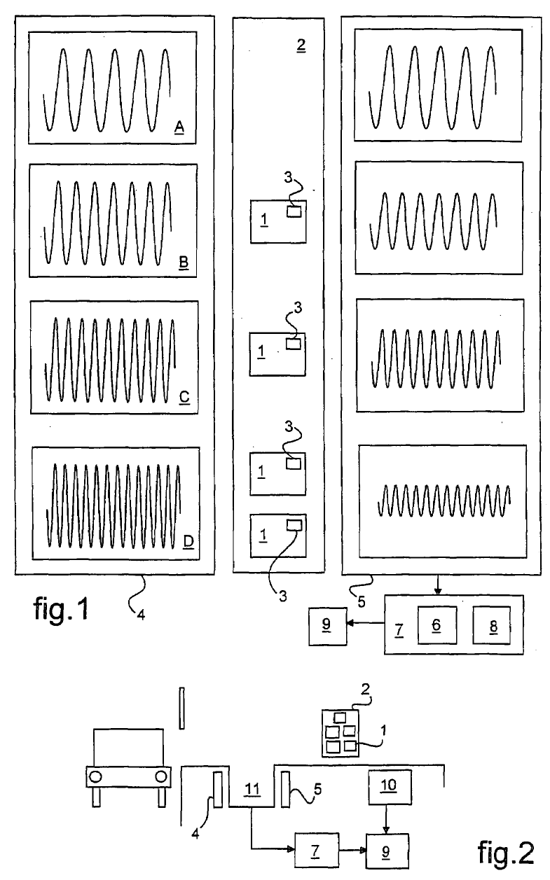

In FIG. 1, articles 1 are contained in bulk within a receptacle 2. Each of the articles 1 is fitted with a label 3 of the RLC type for identification purposes and for quantification purposes when the receptacle 2 goes through a space arranged between a transmitter member 4 for transmitting radiofrequency signals and a receiver member 5 for receiving the transmitted signals. When an article 1 passes through the space situated between the transmitter member 4 and the receiver member 5, it attenuates the transmitted signal received by the receiver member. It should be observed that in a variant that is not shown, the apparatus may comprise a plurality of systems each associating a transmitter member 4 with a receiver member 5 oriented in respective different directions of a rectangular frame of reference. Such an arrangement presents the advantage of providing better coverage for reading the signals received by the various receiver members 5, and of providing reading that is more uniform.

In order to identify the articles 1 by article type, each of them is fitted with an RLC label 3 that is resonant at a determined frequency. The transmitter member 4 transmits a plurality of signals sequentially at respective frequencies corresponding to the frequencies of the various RLC labels 3 fitted to each of the types of article 1. As an indication, the transmitted signals lie in a frequency range of about 1 MHz to 40 MHz, with each of the signals being transmitted for a transmission time of about 10 ms. As a result, if for a signal transmitted at a given frequency and a given amplitude, the amplitude of the signal received is attenuated, then the presence within the receptacle 2 of an article 1 of the corresponding type is detected, as shown by way of example for transmitted signals B, C, and D. The receiver member 5 detecting a transmitted signal of an amplitude that is not attenuated corresponds to the absence within the receptacle 2 of any article 1 of the corresponding type, as shown by way of example for transmitted signal A. The duration required for transmitting a sequence A, B, C, and D is of the order of 1 s.

In addition, the receiver member 5 is fitted with measurement means 6 for measuring the amplitude of any attenuation in the amplitude of the signals it receives. As a result, depending on the magnitude of the attenuation of the amplitude of the signal, the number of articles 1 for a given type of article 1 can be determined, as shown by way of example for transmitted signal D.

The apparatus is also fitted with a computer 7 in communication with memory means 8 that associate each type of RLC label 3 with the corresponding type of article 1 in order to make use of the information generated by the receiver member 5 detecting signals, and in order to deduce therefrom the presence or absence of articles 1 and also the number of articles for each type of article 1. Display means 9 enable the content of the receptacle 2 in terms of article type and the numbers of articles 1 contained therein.

In FIG. 2, an apparatus of the present invention is used for monitoring consistency between an order for articles 1 and the articles 1 that are delivered. In the example shown, this application applies to the field of fast food provision, to the station where orders are delivered that is commonly referred to as a “drive-through station,” where a vehicle driver makes an order that is delivered directly to the driver in the vehicle.

When the driver makes an order with an operator, the operator inputs the nature of the order into a computer 10 or the like, and more particularly the types and the numbers of articles 1 for making up the order. It will be understood that these input means 10 are means associated with the apparatus of the present invention, optionally forming an integral portion of the apparatus, and that these input means 10 may be of any kind without departing from the specified scope of the invention.

The operator prepares the order and places the articles 1 in a receptacle 2. The articles 1 are wrapped in individual packaging of the kind suitable for carrying the RLC label 3 corresponding to the type of article 1. Once the order has been prepared, the operator places the receptacle in a verification station 11 such as a compartment, a tunnel, or the like, corresponding to a space disposed between the transmitter member 4 and the receiver member 5. The sequence of signals is transmitted and the information relating to reception of these signals is analyzed by the computer 7. The display means 9 enable the operator to see the numbers and types of articles 1 contained in the receptacle 2, and the operator verifies that the articles 1 handed over correspond to the order. When the prepared order does indeed correspond, the operator can hand the order over to the driver.

What is claimed is:

1. Apparatus for detecting articles (1) implementing radiofrequency type means for identifying and counting articles in bulk, the apparatus implementing at least one transmitter member (4) for transmitting a signal at given frequency and amplitude, at least one receiver member (5) for receiving the transmitted signal, and at least one RLC type element (3) associating a resistor, an inductor, and a capacitor, each article (1) for detection being fitted with such an RLC element (3), whereby passage of the article (1) through a space (11) extending between the transmitter member (4) and the receiver member (5) induces attenuation in the amplitude of the transmitted signal which is detected by the receiver member (5), said detected attenuation generating information, wherein the transmitter member (4) is a member for sequentially transmitting a plurality of signals (A, B, C, D) at respective frequencies, and the articles (1) are distributed by article type, each article (1) of any one type being fitted with an element (3) of the RLC type that is resonant at a respective frequency corresponding to the different signals (A, B, C, D) that are transmitted sequentially, such that when a batch of articles (1) of different types in bulk passes through the space (11) extending between the transmitter member (4) and the receiver member (5), attenuation is generated in the amplitude of the transmitted signals (A, B, C, D) corresponding to each type of article (1) present in the batch, which attenuation is detected by the receiver member (5), thereby generating corresponding information relating at least to the presence or absence of an article (1) of type identified by the RLC element (3) of the specific type carried by said article, and detection by the receiver member (5) of the attenuation in the amplitude of a signal at a given frequency generates information relating to the quantity of articles (1) of a given type, with quantity being detected on the basis of measuring the magnitude of the attenuation in the detected signal, the apparatus being fitted with such measurement means (6).

2. Apparatus according to claim 1, wherein said measurement of the magnitude of detected signal attenuation corresponds to measuring said attenuation in steps, each step corresponding to some number of RLC elements (3) of corresponding type present in the space (11) extending between the transmitter member (4) and the receiver member (5).

3. Apparatus according to claim 1, wherein the signals (A, B, C, D) transmitted by the transmitter member (4) lie in a frequency range extending from about 1 MHz to about 40 MHz.

4. Apparatus according to claim 1, wherein the duration for which each of the sequentially-transmitted signals (A, B, C, D) is transmitted is about 10 ms.

5. Apparatus according to claim 1, wherein the duration of transmission of a signal sequence (A, B, C, D) is about 1 s.

6. Apparatus according to claim 1, including a computer (7) for compiling the information generated by detecting the attenuations detected by the receiver member (5), the computer (7) being in communication with memory means (8) associating each type of RLC element (3) with the corresponding type of article (1).

7. Apparatus according to claim 6, including display means (9) associated with the computer (7) to display at a control station the types of article (1) detected in the space (11) extending between the transmitter member (4) and the receiver member (5).

8. Apparatus according to claim 6, wherein it is associated with input means (10) and storage means for inputting and storing an order for articles (1) of determined types and numbers, and comparator means between the order and the articles detected on passing between the transmitter member (4) and the receiver member (5) so as to generate, where appropriate, an alert in the event of the articles (1) of the order not matching the detected articles (1).

9. Apparatus according to claim 1, wherein it has a plurality of transmitter member (4) and receiver member (5) pairs oriented along respective directions in a rectangular frame of reference, with the space extending between these various transmitter member (4) and receiver member (5) pairs, thereby enabling the information generated to be made more pertinent.

10. The use of apparatus according to claim 1 for monitoring an order for articles (1) for validity relative to articles (1) detected in the space (11) extending between the transmitter member (4) and the receiver member (5).

11. A use according to claim 10 in the fast food business.

12. The use of apparatus according to claim 1 as antitheft apparatus.

13. A method of implementing apparatus according to claim 1, the method consisting:
in inputting and storing an order comprising at least one article (1) of at least one article type;
in preparing the order and placing articles (1) corresponding to said order in bulk in a receptacle (2), each article (1) being fitted with an RLC element (3) of a type that corresponds to the type of the article (1);
in placing the receptacle (2) containing the articles (1) in a space (11) extending between the transmitter member (4) and the receiver member (5);
in sequentially transmitting different signals (A, B, C, D) at respective frequencies from the transmitter member (4), and in detecting any attenuation in each of the transmitted signals;
in comparing the type and number of the articles (1) as detected with the corresponding articles (1) in the order; and
where appropriate, generating information relating to a mismatch between the order as input and the articles (1) contained in the receptacle (2).
